(19) United States
(12) Patent Application Publication
(10) Pub. No.: US 2006/0140405 A1
(43) Pub. Date: Jun. 29, 2006

(54) Protecting content objects with rights management information

(75) Inventors: John Thommana, Austin, TX (US); Debashish Purkayastha, Pottstown, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/285,952

(22) Filed: Nov. 23, 2005

Related U.S. Application Data
(60) Provisional application No. 60/630,871, filed on Nov. 24, 2004.

(51) Int. Cl. H04N 7/167

(52) U.S. Cl. 380/201

(57) ABSTRACT

A method for protecting a content object with rights management information begins by creating a content object. Permissions are assigned to the content object, an encryption key is generated, and a content protection utility is cloned. The cloned content protection utility, the encryption key, and the permissions are appended to the content object to create a composite object. The composite object is encrypted with the encryption key to create a protected content object.

### CROSS REFERENCE TO RELATED APPLICATION

This application claims the benefit of U.S. Provisional Application No. 60/630,871, filed Nov. 24, 2004, which is incorporated by reference as if fully set forth herein.

### FIELD OF INVENTION

The present invention generally relates to rights management for content objects, and more particularly, to a method and system for protecting content objects with rights management information.

### BACKGROUND

Advancements in technology have improved miniaturization technology to a sufficient level that devices that were once considered standalone have now been aggregated. For example, cameras and microphones that were once considered standalone are now being integrated into cellular phones and other wireless devices, permitting users to create multimedia content with their wireless device.

The absence of content-related security mechanisms makes it difficult to track an offender when an attempt is made to violate ownership rights in the content and make unauthorized use of the content for personal gain without the content owner's consent.

### SUMMARY

The present invention provides a mechanism to record the ownership of a content object into the content object and provides a mechanism for accessing and manipulating the content object using a rights expression language. The mechanism addresses the problem of “repudiation and auditing” by encrypting the content and adding metadata locally in the device on which the content object is created.

A method for protecting a content object with rights management information begins by creating a content object. Permissions are assigned to the content object, an encryption key is generated, and a content protection utility is cloned. The cloned content protection utility, the encryption key, and the permissions are appended to the content object to create a composite object. The composite object is encrypted with the encryption key to create a protected content object.

A method for manipulating a protected content object begins by extracting a content protection utility from the protected content object and executing the content protection utility. A user is authenticated to access the protected content object. The protected content object is decrypted to unlock a content object if the user is authenticated, and the unlock content object can be manipulated.

A system for protecting a content object includes a permission indicator for the content object, an encryption key generator, a content protection utility cloning device, and an appending device. The permission indicator relates to a level of permitted access to the content object. The encryption key generator is configured to generate an encryption key. The content protection utility cloning device is configured to clone a content protection utility. The appending device is configured to append the permission indicator, the encryption key, and a cloned copy of the content protection utility to the content object, thereby creating a protected content object.

A content object protected with rights management information includes a cloned copy of a content protection utility; a permission indicator, relating to a level of permitted access to the content object; and an encryption key, which is used to encrypt and decrypt the content object.

A content creation device for protecting a content object including a permission indicator relating to a level of permitted access to the content object includes an encryption key generator, a content protection utility cloning device, and an appending device. The encryption key generator is configured to generate an encryption key. The content protection utility cloning device is configured to clone a content protection utility. The appending device is configured to append the permission indicator, the encryption key, and a cloned copy of the content protection utility to the content object, thereby creating a protected content object.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a flowchart of a method for protecting a content object with rights management information;

FIG. 2 is a diagram of a protected content object with rights management information;

FIG. 3 is a flowchart of a method for manipulating a protected content object;

FIG. 4 is a diagram of decrypting a protected content object; and

FIG. 5 is a block diagram of a system for protecting content objects and manipulating protected content objects.

### DETAILED DESCRIPTION OF THE PREFERRED EMBODIMENTS

Hereafter, the term “wireless device” includes, but is not limited to, a wireless transmit/receive unit, a user equipment, a mobile station, a fixed or mobile subscriber unit, a pager, or any other type of device capable of operating in a wireless environment. When referred to hereafter, the term “base station” includes, but is not limited to, a Node B, a site controller, an access point, or any other type of interfacing device in a wireless environment.

The present invention relates to a mechanism that records the ownership of a content object into the content object and provides a mechanism for accessing and manipulating the content object using a rights expression language, for example. The mechanism addresses the problem of “repudiation and auditing” by encrypting the content and adding metadata locally in the device on which the content object is created. Every device capable of creating content includes a standard content protection utility, which is the only interface to the created content. The content protection utility has the capability to interface with commonly available commercial off the shelf (COTS) media creation, modification, and utilization software.

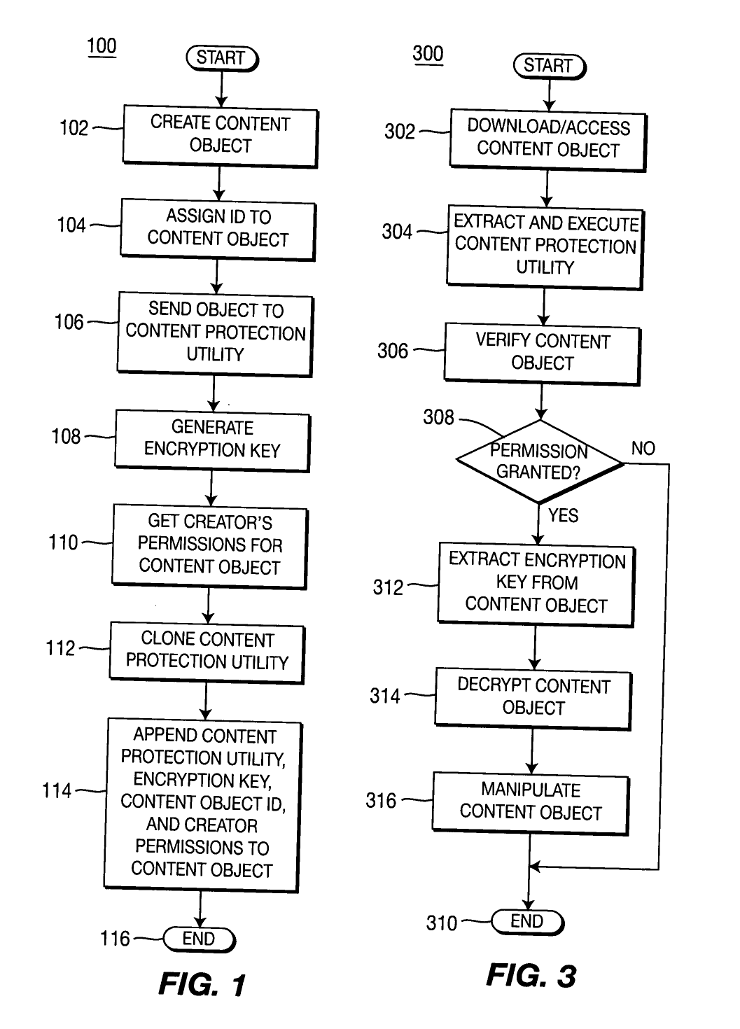

FIG. 1 is a flowchart of a method 100 for protecting a content object with rights management information. The method 100 begins with a user creating a content object on a content creation device, such as a camera, camcorder, or speech recorder (step 102). An identification (ID) is assigned to the content object (step 104). The ID can include information relating to the device on which the content object was created. For example, if the content creation device is a wireless device, the ID can include an International Mobile Equipment Identity (IMEI) or an International Mobile Subscriber Identity (IMSI).

The content object is sent to a content protection utility resident on the content creation device (step 106). The content protection utility generates a one-time use encryption key that is used to encrypt the content object (step 108). The content protection utility obtains the content object creator's permissions for the content object (step 110). The permissions can be stored in a creator's personal verification and authorization database (using some form of Rights Expression Language (REL)). The permissions relate to each object, which are referenced in the database by the content ID.

The content protection utility then clones itself (step 112). The cloned content protection utility, the encryption key, the content object ID, and the content object creator's permissions are all appended to the encrypted content object (step 114) and the method terminates (step 116). Either the entire creator permissions database is appended to the content object or an address of the location of the database is appended to the content object; this decision is implementation-specific.

The new content object that is created via the method 100 can be manipulated only by the standard interfaces provided by the contention protection utility. Since the encryption key is known only to the cloned content protection utility, commonly available COTS media creation, modification, and utilization software cannot manipulate the content object without accessing the content protection utility.

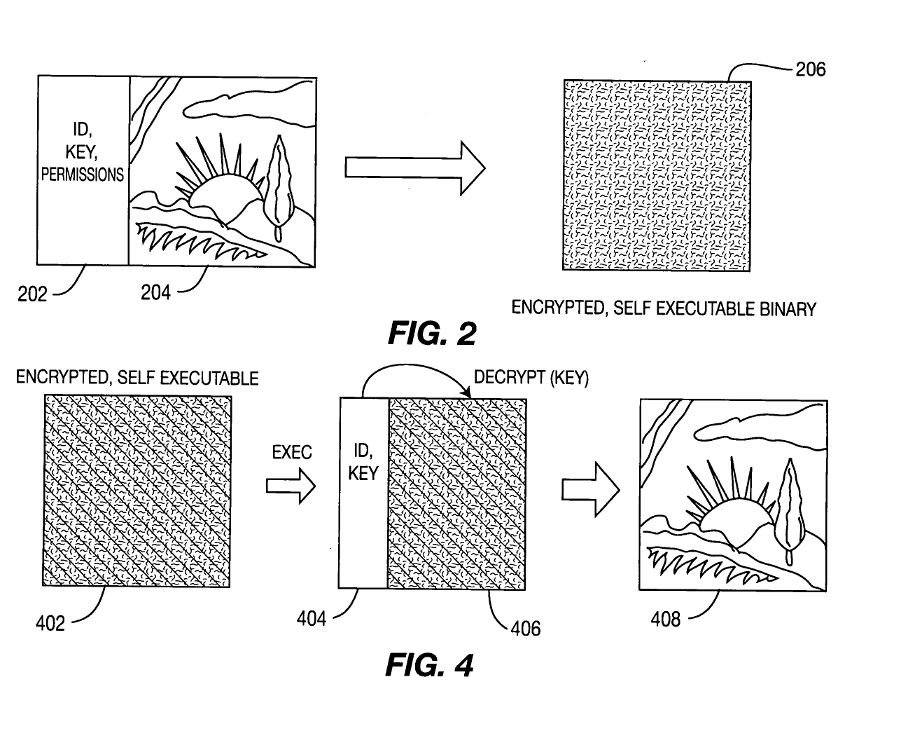

FIG. 2 is a diagram of a protected content object with rights management information, created using the method 100. The content object ID, encryption key, and object permissions 202 are appended to a content object 204, creating an encrypted, self-executing content object 206. The content object 206 is available as an independent self-extracting and self-executing program capable of running on all hardware and software platforms (for example, REL over JAVA).

Whenever the protected content object is accessed, it has to be provided with access authorization, for example by using the REL format. The identity and access authorization provided is verified by the content protection utility by accessing the creator's personal authorization and verification database. Once the authorization is successfully completed, based on the permissions granted to the user, the content can be manipulated. This mechanism is lightweight and efficient. The creator can grant or revoke permission for any created content object dynamically by adding or deleting usage entries from the database.

FIG. 3 is a flowchart of a method 300 for manipulating a protected content object. The method 300 begins with a user downloading or accessing a protected content object (step 302). The protected content object automatically extracts and executes the content protection utility (step 304). The content object is then verified (step 306). Verifying the content object includes looking up the content object ID in the creator's permission database (which is appended to the content object) and determining the content object's permissions based on the content object's ID. The permissions provided dictate the manipulations that the user can perform on the content object. Another approach to verifying the content object uses the content ID and an address to the database (which is appended to the content object). The content protection utility would access the database remotely and verify the content object using the content ID.

If permission is not granted to access the content object (step 308), then the method terminates (step 310). If permission is granted to access the content object (step 308), then the content protection utility extracts the encryption key from the protected content object (step 312) and decrypts the protected content object (step 314). The user is then able to manipulate the content object (step 316) and the method terminates (step 310).

Subsequent modifiers of this “unlocked” content object will inherit the modification permissions of the parent content objects. A new content object can be created by modifying an existing content object, only if the user has permission to do so. The new content object created will authorize users based on the information stored in the new content object.

FIG. 4 is a diagram of decrypting a protected content object. An encrypted, self-executable content object 402 is executed, to separate the content object ID and encryption key 404 from the encrypted content object 406. The encrypted content object 406 is decrypted using the encryption key 404 to unlock the content object 408, which can then be displayed or otherwise manipulated by a user.

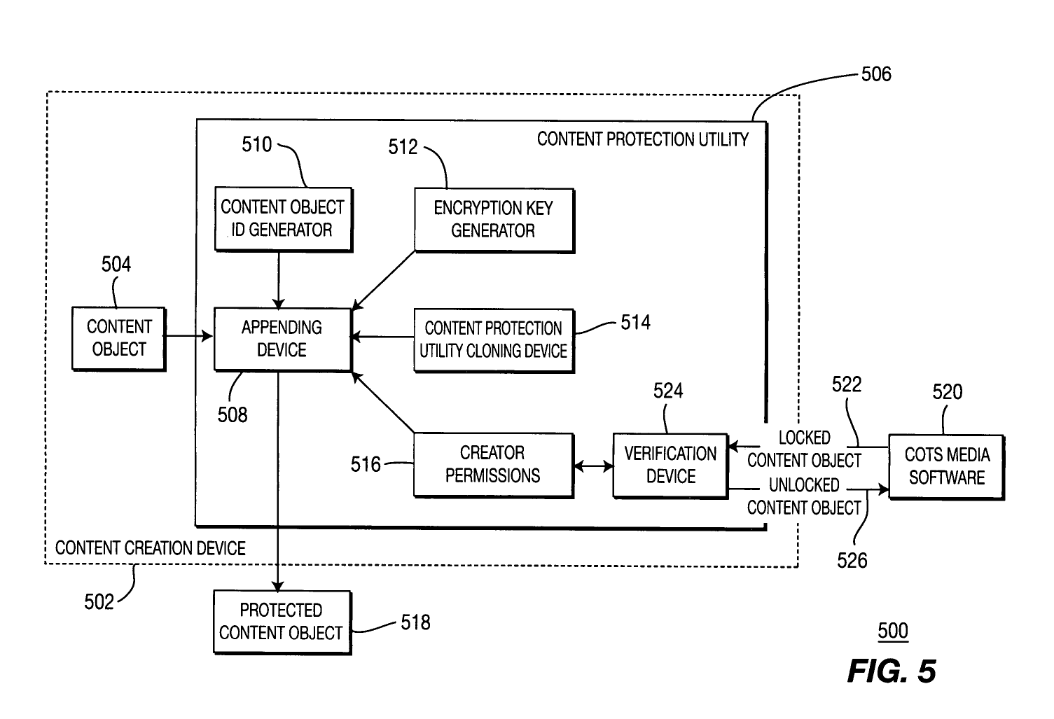

FIG. 5 is a block diagram of a system 500 for protecting content objects and manipulating protected content objects. A user of a content creation device 502 creates a content object 504. It is noted that the content creation device 502 can include a variety of devices, such as a wireless device with multimedia content creation capabilities. The content object 504 is sent to a content protection utility 506, where it is received by an appending device 508.

A content object ID generator 508 generates an ID for the content object 504. For example, if the content creation device is a wireless device, the ID can include an International Mobile Equipment Identity (IMEI) or an International Mobile Subscriber Identity (IMSI). An encryption key generator 512 generates a one-time use encryption key. A content protection utility cloning device 514 clones the content protection utility 506. A set of creator permissions 516 are provided for the content object 504.

The appending device 508 appends the content object ID, the encryption key, the cloned copy of the content protection utility, and the creator permissions to the content object 504 and encrypts the composite object with the encryption key to create a protected content object 518.

A protected content object 518 can be later used by COTS media software 520. In order for the software 520 to access the protected content object 518, it must be first unlocked. The locked content object 522 is sent to a verification device 524 in the content protection utility 506. The verification device 524 checks the creator permissions 516 for the locked content object 522 to determine if it can be unlocked. If the content object can be unlocked, the verification device 524 returns an unlocked content object 526 to the software 520 where it can be displayed or otherwise manipulated.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for protecting a content object with rights management information, comprising the steps of:
creating a content object;
assigning permissions to the content object;
generating an encryption key;
cloning a content protection utility;
appending the cloned content protection utility, the encryption key, and the permissions to the content object to create a composite object; and
encrypting the composite object with the encryption key to create a protected content object.

2. The method according to claim 1, wherein the permissions includes a permission list.

3. The method according to claim 1, wherein the permissions includes a pointer to a permissions list located remote from the content object.

4. The method according to claim 1, further comprising the step of:
assigning an identifier to the content object; and
wherein the appending step includes appending the identifier to the content object.

5. A method for manipulating a protected content object, comprising the steps of:
extracting a content protection utility from the protected content object;
executing the content protection utility;
authenticating a user to access the protected content object;
decrypting the protected content object to unlock a content object if the user is authenticated; and
manipulating the content object.

6. The method according to claim 5, wherein the authenticating step is performed by the content protection utility.

7. The method according to claim 5, wherein the authenticating step includes:
extracting permissions from the protected content object; and
examining the permissions to determine whether the user can access the protected content object.

8. The method according to claim 7, wherein the permissions includes a permission list.

9. The method according to claim 7, wherein the permissions includes a pointer to a permissions list located remote from the content object.

10. The method according to claim 5, wherein the authenticating step includes:
extracting an identifier from the protected content object; and
looking up the identifier in a permission list to determine permissions for the protected content object, the permissions indicating whether the user can access the protected content object.

11. The method according to claim 10, wherein the permission list is appended to the protected content object.

12. The method according to claim 10, wherein the permission list is located on a device remote from the protected content object.

13. The method according to claim 5, wherein if the user is not authenticated, then denying access to the protected content object.

14. The method according to claim 5, wherein the decrypting step is performed by the content protection utility.

15. The method according to claim 5, further comprising the step of:
extracting an encryption key from the protected content object; and
wherein the decrypting step uses the encryption key to decrypt the protected content object.

16. A system for protecting a content object, comprising:
a permission indicator for the content object, relating to a level of permitted access to the content object;
an encryption key generator, configured to generate an encryption key;
a content protection utility cloning device, configured to clone a content protection utility; and
an appending device, configured to append the permission indicator, the encryption key, and a cloned copy of the content protection utility to the content object, thereby creating a protected content object.

17. The system according to claim 16, wherein said permission indicator includes a permission list.

18. The system according to claim 16, wherein said permission indicator includes a pointer to a permission list located remote from the content object.

19. The system according to claim 16, further comprising:
an identifier generator, configured to generate an identifier for the content object, said appending device appending the identifier to the content object.

20. A content object protected with rights management information, comprising:
a cloned copy of a content protection utility;
a permission indicator, relating to a level of permitted access to the content object; and
an encryption key, which is used to encrypt and decrypt the content object.

21. The content object according to claim 20, wherein said permission indicator includes a permission list.

22. The content object according to claim 20, wherein said permission indicator includes a pointer to a permission list located remote from the content object.

23. The content object according to claim 20, further comprising:
an identifier, said identifier being unique to the content object.

24. A content creation device for protecting a content object, the content object including a permission indicator relating to a level of permitted access to the content object, the content creation device comprising:
an encryption key generator, configured to generate an encryption key;
a content protection utility cloning device, configured to clone a content protection utility; and
an appending device, configured to append the permission indicator, the encryption key, and a cloned copy of the content protection utility to the content object, thereby creating a protected content object.

25. The content creation device according to claim 24, wherein the permission indicator includes a permission list.

26. The content creation device according to claim 24, wherein the permission indicator includes a pointer to a permission list located remote from the content object.

27. The content creation device according to claim 24, further comprising:
an identifier generator, configured to generate an identifier for the content object, said appending device appending the identifier to the content object.

28. The content creation device according to claim 24, wherein the content creation device is a wireless device.
